(19) United States
(12) Patent Application Publication
(10) Pub. No.: US 2024/0289631 A1
(43) Pub. Date: Aug. 29, 2024

(54) SLATE RECOMMENDER SYSTEM AND METHOD FOR TRAINING SAME

(71) Applicant: NAVER CORPORATION, Seongnam-si (KR)

(72) Inventors: Romain DEFFAYET, Grenoble (FR); Thibaut THONET, La Tronche (FR); Jean-Michel RENDERS, Quaix-en-Chartreuse (FR); Maarten DE RIJKE, Amstelveen (NL)

(21) Appl. No.: 18/524,235

(22) Filed: Nov. 30, 2023

Related U.S. Application Data
(60) Provisional application No. 63/487,070, filed on Feb. 27, 2023.

(51) Int. Cl. G06N 3/092; G06N 3/0455; G06N 3/0475

(52) U.S. Cl. CPC G06N 3/092; G06N 3/0455; G06N 3/0475

(57) ABSTRACT

Methods and systems for training a recommender system implemented by a processor and memory to recommend a slate of items from a collection to a user. A neural network-based decoder is pretrained to generate a slate of items from a representation in a continuous low-dimensional latent space. A reinforcement learning agent in the recommender system is trained to determine an action in the latent space, where the action represents a recommended slate of items from the collection based on a state. The recommendation system comprises the pretrained decoder for generating the recommended slate of items from the action determined by the agent.

### PRIORITY INFORMATION

This application claims priority to and benefit from U.S. Provisional Patent Application Ser. No. 63/487,070, filed Feb. 27, 2023, which application is incorporated in its entirety by reference herein.

### FIELD

The present disclosure relates generally to machine learning, and more particularly relates to neural network-based recommendation methods and systems for recommending a slate of items to a user.

### BACKGROUND

Ubiquitous in online services, recommender systems (RSs) play a significant role in personalization by catering to users' identified tastes. Ideally, they also diversify their offerings and help users discover new interests, such as by providing guidance when exploring selective topics. In the latter case, recommender systems take on an active role, which means that recommendations influence future user behavior. Therefore, their effects on users should be explicitly controlled.

Recommender systems have typically been designed and trained to maximize immediate user engagement. However, a myopic approach can lead to problems such as user boredom and filter bubbles. For instance, users may get bored if too many similar recommendations are made. As another example, users may end up in so-called filter bubbles or echo chambers. From the perspective of an online platform or a content provider, user boredom leads to poor retention and conversion rates, while filter bubbles may raise faimess and ethical issues. On the other hand, recommender systems can positively impact users, for example, when users become interested in new, unexpected topics or when the recommender system offers a fair representation of available options.

Diversity is a key tool for mitigating detrimental effects of recommender systems while encouraging positive outcomes. One way to make diversity emerge in a principled fashion is through the direct optimization of long-term user engagement. Such an objective can penalize short-sighted behavior such as always recommending similar items, and can encourage recommendations that can lead to stronger future engagement.

Reinforcement learning (RL) models can capture the sequential and interactive nature of recommendation. RL models can thus offer a principled way to both address long-term rewards and avoid myopic behaviors in recommender systems.

However, conventional RL approaches become intractable in a slate recommendation scenario, in which, at each interaction turn, a slate recommender system including an RL agent recommends a list of items from a collection. The user interacts with zero, one, or several of those items. Example slate recommendation systems are disclosed in Chen et al., 2019, Top-K Off-Policy Correction for a REINFORCE Recommender System, In WSDM '19. 456-464; le et al., 2019, SlateQ: A Tractable Decomposition for Reinforcement Learning with Recommendation Sets, In IJCAI '19. 2592-2599; and Sunehag et al., Deep Reinforcement Learning with Attention for Slate Markov Decision Processes with High-Dimensional States and Actions, arXiv: 1512.01124 (2015).

In a slate recommendation scenario, users may not examine all the recommended items, which leads to biases in the observed interactions along with a complex interplay between items in the same slate. Additionally, the size of the action space, i.e., the number of possible slates (as a slate may contain any combination of items), prohibits the use of off-the-shelf RL approaches. As slate recommendation is a combinatorial problem, the evaluation of all actions by the RL agent through trial and error is simply intractable. For instance, in an illustrative scenario with as few as 1,000 items in a collection, the number of possible slates of size 10 is approximately 9.6×10²⁹.

### SUMMARY

Provided herein, among other things, are methods and systems for training a recommender system implemented by a processor and memory to recommend a slate of items from a collection to a user. A neural network-based decoder is pretrained to generate a slate of items from a representation in a continuous low-dimensional latent space. A reinforcement learning agent in the recommender system is trained to determine an action in the latent space, where the action represents a recommended slate of items from the collection based on a state. The recommendation system comprises the pretrained decoder for generating the recommended slate of items from action determined by the agent.

According to a complementary aspect, the present disclosure provides a computer program product, comprising code instructions to execute a method according to the previously described aspects; and a computer-readable medium, on which is stored a computer program product comprising code instructions for executing a method according to the previously described embodiments and aspects. The present disclosure further provides a processor configured using code instructions for executing a method according to the previously described embodiments and aspects.

Other features and advantages of the invention will be apparent from the following specification taken in conjunction with the following drawings.

### DESCRIPTION OF THE DRAWINGS

The accompanying drawings are incorporated into the specification for the purpose of explaining the principles of the embodiments. The drawings are not to be construed as limiting the invention to only the illustrated and described embodiments or to how they can be made and used. Further features and advantages will become apparent from the following and, more particularly, from the description of the embodiments as illustrated in the accompanying drawings, wherein:

FIG. 1 shows an example two-stage content recommendation platform for recommending items, incorporating a recommendation system.

FIG. 2 shows an example framework and information flow for a slate recommender system with reinforcement learning.

FIG. 3 shows an example method for training a slate recommender system.

FIG. 4 shows an example method for pretraining a generative model including a decoder and an encoder for modeling slates.

FIG. 5 shows an example training method for training a variational autoencoder (VAE).

FIGS. 6A-6C show a distribution of the relevance scores of items recommended by a short-term oracle, SAC+GeMS with γ=0 and SAC+GeMS with γ=0.8. The myopic approaches (FIG. 6B) led to more boredom than the long-term approach (FIG. 6C). Boredom penalizes item scores and is visualized by orange (darker) areas. The myopic approaches (FIGS. 6A, 6B) lead to more boredom than the long-term approach (FIG. 6C), and therefore to lower average item scores (solid red (vertical) lines).

FIG. 7 shows an average cumulative number of clicks on the test set for 6 simulated environments, where bold: best method; underlined: 2nd-best method; t: statistically significantly better than all other methods. 95% confidence intervals are shown inside parentheses. Methods grouped under “Disclosed env.” have access to privileged information about the environment and can therefore not be fairly compared with “Undisclosed env.” methods. The six rightmost columns correspond to six different simulated environments.

FIGS. 8-9 show average cumulative number of clicks on the validation set obtained by SAC+GeMS with its best validation checkpoint, for different values of β and λ. 95% confidence intervals are also displayed.

FIG. 10 shows an example network architecture in which example recommender systems and methods may be implemented.

In the drawings, reference numbers may be reused to identify similar and/or identical elements.

### DETAILED DESCRIPTION

There is a misalignment between short-term benefits and long-term user engagement, as well as a tendency of traditional recommender systems to be detrimental to long-term outcomes. Such myopic behavior is known to cause boredom and decrease user retention, which is prejudicial for both users and content providers. This behavior also raises concerns such as the rich-get-richer issue and feeding close-mindedness. Previous disclosed methods have attempted to counter these effects by explicitly maximizing diversity or by finding metrics correlated with long-term outcomes.

For slate recommendation methods and systems, it is useful to balance exploitation (i.e., sticking to the known interests of a user) and exploration (i.e., further probing the user's interests). This balance helps to avoid always recommending similar items, and to encourage recommendations that boost future engagement. Example systems and methods herein can directly optimize long-term metrics by using reinforcement learning algorithms. Examples of RL algorithms used in optimizing long-term metrics are disclosed in Chen et al., 2019, Top-K Off-Policy Correction for a REINFORCE Recommender System, In WSDM '19. 456-464; Hansen et al., Shifting Consumption towards Diverse Content on Music Streaming Platforms, In WSDM '21. 238-246; and Zou et al., Reinforcement Learning to Optimize Long-Term User Engagement in Recommender Systems. In KDD '19. 2810-2818.

Previous reinforcement learning models and algorithms have been disclosed that aim to optimize long-term metrics by acknowledging the causal effect of recommendations on users. To address the problem of intractability, such approaches provide one or more well-chosen decompositions of actions. However, such approaches typically rely on restrictive and sometimes even unrealistic assumptions.

Example systems and methods provided herein encode slates in a continuous, low-dimensional latent space learned by a generative model, such as a variational auto-encoder (VAE). A reinforcement learning (RL) agent, e.g., of a ranker, chooses continuous actions from this latent space, which actions are conditioned on the current state. These continuous actions are ultimately decoded into the corresponding slates.

Example systems and methods can provide various features and benefits, such as ability to relax assumptions that have been required by previous methods in the art. Example systems and methods can also improve the quality of the action selection over prior methods by modeling full slates instead of independent items, such as by enabling diversity.

Experiments performed on a wide array of simulated environments confirm the effectiveness of example methods, which can be based on a principle referred to herein as generative modeling of slates (GeMS) methods, over baselines in practical scenarios where the restrictive assumptions underlying the baselines are lifted. Results suggest that representation learning using generative models can be successfully implemented in generalizable RL-based slate recommender systems.

Content Recommendation Platform with Ranker

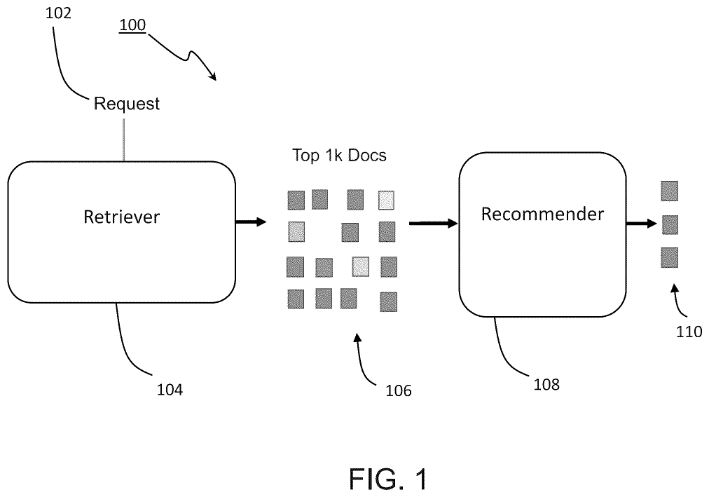

Referring now to the drawings, FIG. 1 shows an example two-stage content recommendation platform 100 for recommending items, such as but not limited to a recommendation engine or a search engine.

In a first stage, a request or prompt (request) 102 may be input to a retriever 104. The request 102 may be input, e.g., from a user, from another part of the content recommendation platform 100, from a remote computer, etc. Example requests include but are not limited to push or pull requests for providing one or more items (of any format). The retriever 104 retrieves a collection of items 106 (e.g., unique identifiers (IDs) respectively associated with the items, or any combination of the items and the IDs). The items in the collection may include, for instance, media items, documents, tokens, news items, terms, e-commerce items, or a combination thereof.

In a second stage, for each turn of interaction in an episode, a ranker embodied in a recommender system 108 outputs a recommended slate 110 of items to a user from the collection of items 106. For instance, the recommended slate 110 of items may be transmitted to a user device (e.g., a web browser, application (app), etc.), provided for display on a display (e.g., a screen), printed, provided for presenting by a virtual assistant or bot, etc. The user can then respond by interacting with the provided slate of items, including interacting with (e.g., clicking on or otherwise selecting or indicating a selection of), zero, one, some, or all of the items in the slate. The response is received by the recommender system 108 and processed to provide a new recommended slate 110 in a subsequent turn. The recommender system 108 includes a reinforcement learning (RL) model that is trained to take an action (i.e., recommend a slate 110 for each turn) to optimize a reward. It will be appreciated that an example recommender system 108 may instead be provided without the first stage 104, or with a different first stage).

The number of items in the slate 110 is fewer than the number of items in the collection 106. In an example practical scenario (S) for illustrating inventive features and benefits of example slate recommendation systems, including but not limited to tractability and feasibility, the collection of items 106 contains around a thousand items, and at each turn of interaction the example recommender system 108 selects and ranks ten items to be presented to the user. This scenario, for instance, fits the second stage ranking phase of many content recommendation platforms; for example, see Van Dang et al. Two-Stage Learning to Rank for Information Retrieval, in ECIR '13. 423-434. It will be appreciated, however, that the number of items in the collection 106 and/or the number of items in the collection that are selected and ranked for presentation to the user can be greater or fewer than 1000 and 10, respectively.

To reduce the prohibitively large size of the combinatorial action space for the reinforcement learning model under such a scenario, it has been proposed in the art to decompose slates in a tractable manner, but at the cost of restrictive assumptions. Such assumptions concern, e.g., mutual independence of items in the slate, knowledge of the user click model, availability of high-quality item embeddings, knowledge that at most one item per slate is clicked, etc. These example assumptions are explained in more detail below.

By contrast, example slate recommender systems according to embodiments herein first learn a continuous, low-dimensional latent representation of actions (i.e., slates). Then, the reinforcement learning agent (RL agent) can take actions, which may be referred to as proto-actions (as opposed to the final slate that is present to the user), within this latent space during its training phase. In example embodiments, the latent representations are obtained by generative modeling methods. Example methods employ an autoencoder, such as a variational auto-encoder (VAE), that is pretrained on logged interactions, such as observed slates and associated interactions, e.g., clicks. The dataset may be generated offline, generated based on prior interactions with the user, or generated based on prior interactions at least partially with users other than the user. For example, observed slates and interactions (e.g., clicks) may be collected from a previous version of the recommender system. Such a dataset is usually available in recommendation settings.

Example slate recommender systems employing generative modeling of slates need not rely on restrictive assumptions, such as the example assumptions listed above, to provide for tractability. Additionally, by representing full slates, example methods enable the RL agent to improve the quality of its recommendations, instead of, say, using individual item representations.

### Example Slate Recommender System

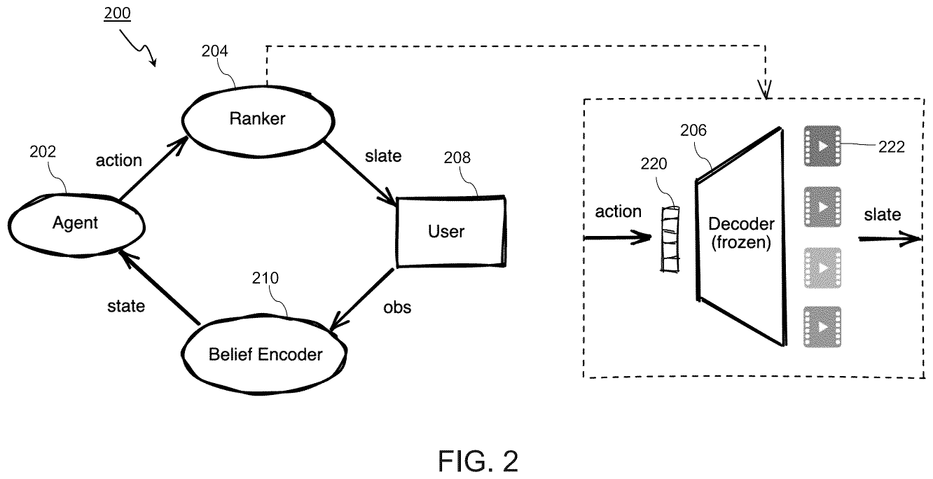

FIG. 2 shows an example framework and information flow for a slate recommender system 200 with reinforcement learning. The slate recommender system 200 includes an agent 202 embodied in or including a neural network-based reinforcement learning (RL) agent. The agent 202 is connected (directly or indirectly) to a ranker 204 embodied in or including a neural network-based decoder 206 of a pretrained variational autoencoder (VAE). The ranker 204 outputs a recommended slate of items to a user 208, which provides an environment interacting with the agent 202. A belief encoder 210 is connected (directly or indirectly) to the agent 202 and to the user 208.

In an example operation of the slate recommender system 200, the interactions with the environment, such as the user 208, can generally be described by the following repeated steps (e.g., turns in an episode):
The belief encoder 210 summarizes a history of interactions (e.g., observed interactions) (“obs”) with the user 208 into a state (“state”), e.g., embodied in a state vector;
The agent 202 determines (e.g., selects) an action (“action”) 220 based on this state; and
The ranker 204 reconstructs a recommended slate of items by decoding this action, received from the agent, into a slate.
The ranker 204 outputs, e.g., serves, indirectly or directly, the reconstructed slate (“slate”) to the user 208, who can interact with one or more items in the slate.

### Training the Slate Recommender System

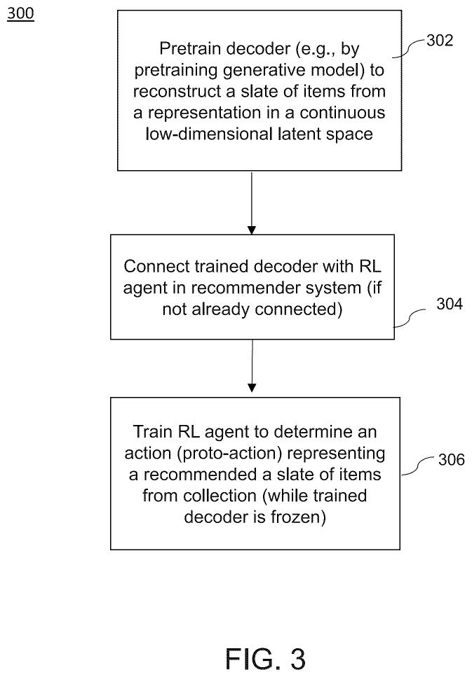

FIG. 3 shows an example method 300 for training a slate recommender system, such as slate recommender system 200, to recommend a slate of items from a collection to a user. A neural network-based decoder, such as provided for the ranker 204, is pretrained to reconstruct a slate of items from a representation in a continuous low-dimensional latent space at 302. This pretraining includes pretraining a generative model, e.g., a variational autoencoder, that includes the decoder and a neural network-based encoder. The trained (pretrained) decoder is directly or indirectly connected to (or integrated with, or incorporated into the slate recommender system with) an RL agent at 304, such as the agent 202. If the trained decoder is already directly or indirectly connected to (or integrated with or incorporated into the slate recommender system with) the RL agent, this step 304 can be omitted.

The RL agent is then trained to determine an action, e.g., a proto-action (as distinguished from the final slate presented to the user) in the latent space (continuous, low-dimensional) at 306. This action represents a recommended slate of items from the collection. The RL agent training 306 preferably takes place while the connected pretrained decoder is frozen. In operation of the recommender system, the pretrained frozen decoder, e.g., the decoder of the VAE, is used to generate the RL agent's action in the latent space into a slate of items.

### Formal Model of RL-Based Recommender System

While a formal description of example generative models, RL models, and slate recommendation system models is provided herein to illustrate example features and benefits, it will be appreciated that the models can vary as will be appreciated by those of ordinary skill in the art.

Consider a slate recommendation scenario, in which a user (e.g., user 208) interacts with a recommender system (e.g., recommender system 200) (RS) in a turn-by-turn manner throughout an episode of T turns. At every turn t∈{1, . . . , T}, the recommender system recommends a slate aₜ=(iₜ¹,iₜ^{k}) where (iₜ^{j})_{1≤/≤k} are items selected from a collection [symbol] and k is the size of the slate, e.g., as set by the RS designer. The user can interact with (e.g., click on, select zero, one or several items in the slate and the resulting interaction (click) vector cₜ=(cₜ¹, . . . , cₜ^{k}), cₜ^{j}∈{0,1} is returned to the RS.

The problem of maximizing the cumulative number of interactions (e.g., clicks) throughout an episode (an example long-term objective) can be modeled by a Partially Observable Markov Decision Process (POMDP) [symbol] =( [symbol] , [symbol] , [symbol] ,R,T,Ω) defined by:
A set of states s∈ [symbol] , which represent the unobservable state of the user's mind;
A set of observations [symbol] accessible to the recommender system. Here, observations are interactions (e.g., clicks) from the previous interaction (oₜ=cₜ₋₁) and therefore lie in the space of binary vectors of size k: [symbol] ={0,1}^{k};
A set of actions [symbol] , which is the set of all possible slates composed of items from the collection, i.e.

$$\vert 𝒜 \vert = \frac{\vert 𝒥 \vert !}{( \vert 𝒥 \vert - k ) !} ;$$

A reward function R: [symbol] × [symbol] → [symbol] , which can be set to R(sₜ,aₜ)=rₜ=Σⱼ₌₁^{k}cₜ^{j} in order to reflect the example long-term objective of maximizing the cumulative number of clicks (generally, interactions); and
A set of unknown transition and observation probabilities, respectively T: [symbol] × [symbol] × [symbol] →[0,1] and Ω: [symbol] × [symbol] × [symbol] →[0,1], as well as a distribution over initial states [symbol] ¹: [symbol] →[0,1].

Due to the unobserved nature of the true user state in the POMDP, one can instead train agents by relying on a proxy of the state inferred from available observations. An example method to train agents in POMDPs is to maintain a belief about the current state. Formally, one can define the set [symbol] of all possible belief states, i.e. all distributions b over states s∈ [symbol] , and apply RL algorithms in the Belief MDP [symbol] =( [symbol] , [symbol] , [symbol] , [symbol] ) with [symbol] (b,a)=Σs∈ [symbol] b(s)R(s,a) and [symbol] (b,a,b′)=Σo∈ [symbol] P(b′|b,a,o)Σs∈ [symbol] Ω(o|s,a)b(s).

In an example method, one can assimilate [symbol] to [symbol] ^{d}, d∈ [symbol] , and model P(b′|b,a,o) as a parameterized function b_{ψ}: [symbol] × [symbol] [symbol] ^{d}→ [symbol] ^{d}. This function is an example of the belief encoder (e.g., belief encoder 210). An example belief encoder is disclosed in Kaelbling et al., Planning and Acting in Partially Observable Stochastic Domains. Artificial Intelligence 101, 1 (1998), 99-134.

One can also define the concept of policies π: [symbol] × [symbol] →[0,1] and trajectories τ=(oₜ,aₜ,rₜ)_{1≤t≤T}. In example methods, τ˜π can be provided to signify that a trajectory can be obtained by first sampling an initial state s₁ from S¹ and then recursively sampling actions T−1 times from the policy π. The goal can then be formulated as finding an optimal policy, i.e., a policy maximizing the expected return π*∈ arg max [symbol] _{τ˜π}[ [symbol] (τ)] with [symbol] (τ)=Σₜ₌₁^{T}rₜ.

Reinforcement Learning generally refers to a learning paradigm which allows learning policies leading to high return by reinforcing, through trial and error, the agent's estimate of the expected return [symbol] _{τ˜π}[ [symbol] (t)]. An RL agent improves its policy π through a succession of policy evaluation and policy improvement steps.

In some example RL methods, a state value function V^{π}(s)= [symbol] _{a˜π(s)}[Q^{π}(s,a)] and a state-action value function (or simply Q-function) Q^{π}(s,a)= [symbol] _{τ˜π,s}_{₁}_{=s,a}_{₁}_{=a[} [symbol] _{(τ)] may describe the expected return when starting respectively in state s and with the state-action couple (s,a). Other example RL methods may compute only the Q-function or the state value function, while still other example RL methods may not explicitly estimate either the Q-function or the state value function.}

RL Methods based on Q-Learning evaluate directly the Q-function of the optimal policy during the policy evaluation step and derive a policy which ϵ-greedily maximizes the estimated Q-function at each timestep. Conversely, RL methods based on policy gradients (e.g., REINFORCE) or actor-critic (e.g., SAC) estimate the expected return of their current policy and use gradient ascent on this return to improve their policy.

### Pretraining the Generative Model

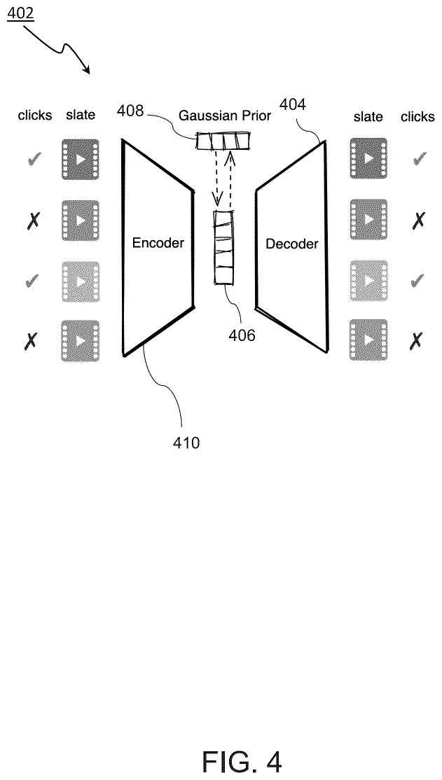

FIG. 4 shows an example method for pretraining a generative model 402 including a neural network-based decoder 404 for modeling slates. The pretrained decoder 404 can then be frozen and integrated as a ranker (e.g., ranker 204) in an example RL framework such as recommender system 200. An example generative model is a deep generative model that learns a low-dimensional latent space 406 for slates and associated interactions, thus constituting a convenient proto-action space for the RL agent and allowing for tractable RL without the need to resort to restrictive assumptions as in some prior methods.

Providing an example generative model in example methods includes pretraining an autoencoder 402 including the decoder 402 and a neural network based encoder 410 on a precollected dataset [symbol] of logged interactions. The logged interactions can include, for instance, a plurality of data pairs, where each data pair includes a slate of items and a set of associated interactions, e.g., clicks.

An example autoencoder 402 is a variational auto-encoder (VAE), such as disclosed in D. Kingma and M. Welling, Auto-Encoding Variational Bayes, in ICLR '14. The VAE aims to learn a joint distribution over data samples (slates and interactions (e.g., clicks) denoted as a and c, respectively) and latent encodings (denoted as z). To do so, a parameterized distribution p_{θ}(a,c,z) may be trained to maximize the marginal likelihood of the data p_{θ}(a,c)=∫_{z}p_{θ}(a,c,z)dz.

Due to the intractability of this integral in many practical scenarios, a parameterized distribution q_{ϕ}(z|a,c) can be introduced as a variational approximation of the true posterior p_{θ}(z|a,c) and the VAE can then trained by maximizing the evidence lower bound (ELBO):

$${ℒ}_{θ , ϕ}^{ELBO} = {𝔼}_{a , c ∼ 𝒟} [ {𝔼}_{z ∼ {q}_{ϕ} ( \cdot \vert a , c )} [ log {p}_{θ} ( a , c \vert z ) ] - KL [ {q}_{ϕ} ( z \vert a , c ) \vert p ( z ) ] ] , \qquad ( 1 )$$

where p(z) is the prior distribution 408 over the latent space, KL is the Kullback-Leibler divergence (an example prior matching objective), e.g., as disclosed in S. Kullback and R. A. Leibler, On Information and Sufficiency, The Annals of Mathematical Statistics 22, 1 (1951), 79-86, and z is a sample from a Gaussian distribution obtained using the reparameterization trick, e.g., as disclosed in Diederik Kingma and Max Welling, 2014. The distributions q_{ϕ}(z|a,c) and p_{θ}(a, c|z) can be referred to generally as the encoder, e.g., encoder 410, and the decoder 404, respectively.

The downstream performance of the RL agent that is desired to be ultimately learned depends on the upstream ability of the VAE 402 to properly reconstruct slates. However, as disclosed for instance in Liu et al., Variation Control and Evaluation for Generative Slate Recommendations, In WWW '21. 436-448, an accurate reconstruction of slates may limit the agent's capacity to satisfy the user's interests. Finding high-performance continuous control policies involves smoothness and structure in the latent space, which may be lacking if too much emphasis is given to the reconstruction objective in comparison to the prior matching objective enforced by the KL-divergence.

For the above reasons, it is useful to balance reconstruction and controllability. Such balance can be provided in example embodiments by introducing a hyperparameter β as weight for the prior matching objective (KL term) in Equation (1). Moreover, to promote additional structure in the latent space, a click reconstruction term can be added in the loss. Slates with similar short-term outcomes (interactions, e.g., clicks) can be grouped together during pre-training. However, it may be beneficial to avoid biasing the learned representations towards click reconstruction too much, as it may come at the cost of quality of the slate reconstruction. Therefore, a hyperparameter λ can be added to adjust this second trade-off. In general, balancing hyperparameters may be provided for any one or more of the prior matching objective term, the slate reconstruction term, and/or the interaction (click) reconstruction term.

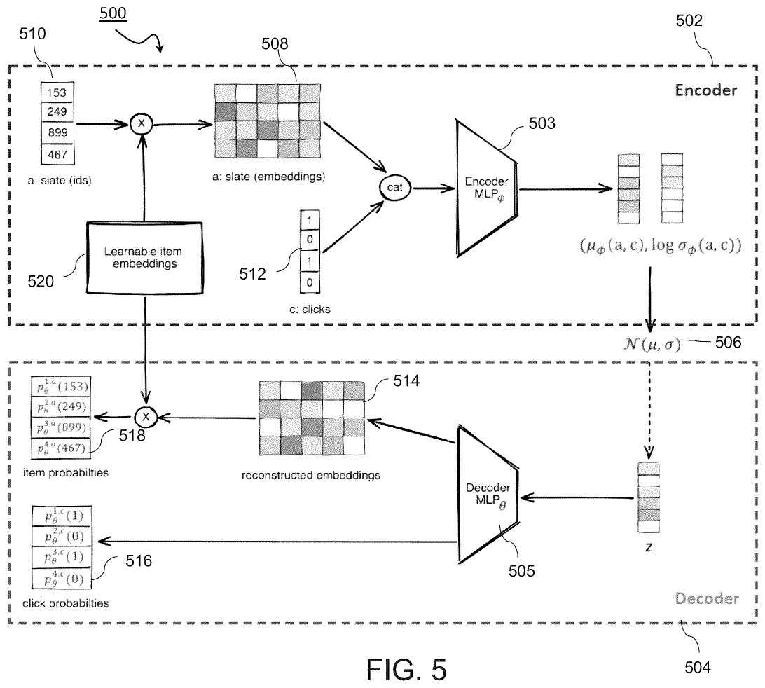

FIG. 5 shows an example training method for a VAE 500 including an encoder 502, including an encoder model 503, and a decoder 504, including a decoder model 505. In the example training method, the prior p(z) is set as a standard Gaussian distribution [symbol] (0,l). The example encoder model q_{ϕ}(z|a,c) 506 is a Gaussian distribution with diagonal covariance [symbol] (μ_{ϕ}(a,c),diag(σ_{ϕ}²(a,c))), parameterized by a multi-layer perceptron (MLP) 503. This MLP inputs the concatenation of learnable item embeddings 508 (from a slate 510 of items, e.g., item ids) and associated clicks 512 over the whole slate, and outputs (μ_{ϕ}(a,c), log σ_{ϕ}+(a,c)). A combination of the embedded slate of items (item embeddings 508) may include a vector having dimensions greater than a dimension (e.g., dimension d) of the latent representation of the slate. As a nonlimiting example, an item embedding may be of size 20 (or more, or less), and for a slate of size 10, a combination (e.g., concatenation) of the slate's item embeddings may be a vector of size 10×20=200, while a dimension d of a vector that is a latent representation is 32 (or more, or less). Providing a lower dimension for the latent representation, among other benefits, helps prevent a simple copy of the input, and ensures at least some degree of compression (and should result in at least some degree of generalization).

In the decoder model p_{θ}(a,c|z) 505, another MLP takes as input the latent sample z, and outputs the concatenation of reconstructed embeddings e_{θ}^{j} (z) 514 and click probabilities p_{θ}^{j,c} (cⱼ|z) 516 for each slot j in the slate. In the decoder 504, logits (i.e., non-normalized scores fed to a function such as a softmax function to produce a probability distribution) are derived for the item probabilities p_{θ}^{j,a}(aⱼ|z) 518 by taking the dot-product of the reconstructed embedding e_{θ}^{j}(z) 514 with the (learnable) embeddings (e.g., the learnable embedding eⁱ 520 of all items in the collection) to define the probability p_{θ}^{j,a}(aⱼ|z) as

$$\frac{exp ( log {it}_{j} )}{{\sum }_{i} exp ( log {it}_{i} )}$$

where logitᵢ=(e_{θ}^{j})(z))^{T}·eⁱ. During pretraining of the VAE, the latent sample z may be sampled from the distribution 506 ( [symbol] (μ_{ϕ}(a,c),diag(σ_{ϕ}²(a,c))). However, after pretraining, when the decoder 504 is connected to the RL agent, z is selected by the RL agent.

For collection items, the current version of embeddings learned within the encoder 502 can be used. As a nonlimiting example, the learning item embeddings in the decoder 504 may be cloned and used to perform the dot-product. However, the gradient is prevented from back-propagating to them, e.g., using a stop-gradient operator, to avoid potential degenerate solutions. In other example embodiments, the learned item embeddings may be a component that is external to the encoder 502 and/or the decoder 504.

In summary, an example VAE can be pre-trained by maximizing the ELBO on the task of reconstructing slates and corresponding clicks, i.e., by minimizing

$${ℒ}_{θ , ϕ}^{GeMS} = {𝔼}_{a , c ∼ 𝒟} [ {ℒ}_{θ , ϕ}^{GeMS} ( a , c ) ] with : \qquad ( 2 )$$

$${ℒ}_{θ , ϕ}^{GeMS} ( a , c ) = {\overbrace{{\sum }_{j = 1}^{k} log {p}_{θ}^{j , a} ( {a}_{j} \vert {z}_{ϕ} ( a , c ) )}}^{Slate reconstruction} + {λ \overbrace{{\sum }_{j = 1}^{k} log {p}_{θ}^{j , c} ( {c}_{j} \vert {z}_{ϕ} ( a , c ) )} +}^{Click reconstruction} {β \overbrace{{\sum }_{i = 1}^{d} ( {σ}_{ϕ , i}^{2} + {μ}_{ϕ , i}^{2} - log {σ}_{ϕ , i} - 1 )}}^{KL - divergence}$$

where z_{ϕ}(a,c)=μ_{ϕ}(a,c)+diag (σ_{ϕ}²(a,c))·ϵ, for ϵ˜ [symbol] (0,l). Here, d is the dimension of the latent space, and β and λ are hyperparameters controlling the respective weight of the KL term and the click reconstruction term. Note that the KL term can take this simple form in the example formula due to the Gaussian assumption on q_{ϕ}(z|a,c) and the [symbol] (0,l) prior.

### Incorporation of the Decoder in the Recommender System

After pretraining the decoder by pretraining the generative model (step 302), the parameters of the decoder can be frozen, and the decoder (e.g., decoder 206, 402, 504) can be used as (or otherwise incorporated in) the ranker 204 in the example RL framework 200 shown in FIG. 2. The RL agent 202 can then be trained (step 306) to maximize a discounted return by taking actions, e.g., proto-actions 220 within the VAE's latent space. As a nonlimiting example, the RL agent 202 can be trained to take continuous actions conditioned on a state in an (apparent) abstract space that may be enforced to be the same dimension as the latent space. For instance, the set of available actions may be constrained to a window around an origin of the latent space. The size of the window may be determined (e.g., selected) based on where samples from the encoder are located. Although this is not required, it can be useful, for instance, to avoid taking actions that are completely outside of the latent distribution.

To generate a slate (i¹, . . . , i^{k}) 222 from the agent's action (proto-action) z, one can take for each slot j∈{1, . . . , k} the most likely item according to the decoder 206, 402, 504:

$${i}^{j} = arg {max}_{i ∈ 𝒥} {p}_{θ}^{j , a} ( i \vert z ) .$$

The generated slate 222 is then output, e.g., directly i€3 or indirectly by the ranker 204, to the user 208.

While the ranker 204 includes or is embodied in example generative models as described by example herein, other components of the recommender system 200 may vary substantially. A nonlimiting example RL framework for the recommender system 200 includes a standard implementation of the RL agent 202 and the belief encoder 210. For instance, the belief encoder 210 may be embodied in (e.g., modeled by) a Gated Recurrent Unit (GRU), e.g., as disclosed in Cho et al., Learning Phrase Representations using RNN Encoder-Decoder for Statistical Machine Translation, In EMNLP '14. 1724-1734. The belief encoder 210 takes as input the concatenation of items and respective clicks from each slate.

The RL agent 202 may be embodied in (modeled by) an actor-critic algorithm such as a Soft Actor-Critic (SAC) algorithm, e.g., as disclosed in Haarnoja et al., Soft Actor-Critic: Off-Policy Maximum Entropy Deep Reinforcement Learning with a Stochastic Actor, In ICML '18. 1856-1865. SAC is a well-established actor-critic algorithm, known for its strong performance and data-efficiency in continuous control with complex dynamics. Additionally, SAC adds an entropy term incentivizing exploration which can be useful to attain higher performance in highly stochastic recommendation environments.

In SAC, the Q-function is embodied as a critic network, i.e., a parametric function Q_{ψ}: [symbol] × [symbol] → [symbol] . Q_{ψ} is trained in an off-policy fashion to approximate the true Q-function of the current policy π_{ξ}. The critic is updated by minimizing a Mean Squared Error (MSE) loss on the Temporal-Difference (TD) target, i.e., one-step lookup of the current model:

$${ψ}^{k + 1} = arg {min}_{ψ} {J}_{Q}^{k} ( ψ ) , with$$

$${J}_{Q}^{k} ( ψ ) = {𝔼}_{( s , a , r , {s}^{′} ) ∼ B} [ {( r + γ {Q}_{{ψ}^{k}} ( {s}^{′} , {a}_{{ξ}^{k}} ( {s}^{′} ) ) - {Q}_{ψ} ( s , a ) )}^{2} ] ,$$

where a_{ξk}(s′)˜π_{ξk}(⋅|s′) is an action sampled from the current policy and B is a buffer containing tuples of experience (state, action, reward, next state) collected earlier during the training. Then the policy (i.e., actor) is updated so as to maximize the return estimate given by the critic:

$${ξ}^{k + 1} = arg {min}_{ξ} {J}_{π}^{k} ( ξ ) , with {J}_{π}^{k} ( ξ ) = {𝔼}_{s ∼ B} [ {Q}_{{ψ}^{k + 1}} ( s , {a}_{ξ} ( s ) ) ] ,$$

where a_{ξ}(s)˜π_{ξ}(⋅|s) is a sampled action. The actor-critic paradigm involves alternating these two steps, respectively called policy evaluation and policy improvement, until convergence.

To address the exploration-exploitation dilemma, SAC adopts a maximum-entropy framework. It includes framing the RL training as a multi-objective optimization problem between reward maximization and randomness of the policy. Concretely, the training objectives of the actor-critic model can be rewritten as follows:

$$\begin{matrix}{J}_{Q}^{k , ent} ( ψ ) = {𝔼}_{( s , a , r , {s}^{′} ) ∼ B} [ {( r + γ {Q}_{{ψ}^{k} , {ξ}^{k} , α}^{ent} ( {s}^{′} ) - {Q}_{ψ} ( s , a ) )}^{2} ] \\ {J}_{π}^{k , ent} ( ξ ) = {𝔼}_{s ∼ B} [ {Q}_{{ψ}^{k + 1} , ξ , α}^{ent} ( s ) ] ,\end{matrix}$$

where Q_{ψ,ξ,α}^{ent}(s)=Q_{ψ}(s,a_{ξ}(s))−α log π_{ξ}(a_{ξ}(s)|s) is the entropy-regularized Q-function and α is a hyperparameter controlling the strength of the entropy regularization.

Further implementation details of SAC methods, such as the choice of policy parameterization, the use of clipped double Q-Learning and target networks, and automatic tuning of the entropy parameter are disclosed by example in Haarnoja et al., Soft Actor-Critic: Off-Policy Maximum Entropy Deep Reinforcement Learning with a Stochastic Actor, In ICML '18. 1856-1865.

It will be appreciated that other models may be used for the belief encoder 210 and/or the RL agent 202 for integration with example generative models in the RL-based recommendation system 200.

### Experiments

Prior methods have required certain assumptions on the environment, i.e., user behavior, to make the combinatorial problem of slate recommendation tractable. Experiments described herein illustrate that on a wide array of simulated environments previous methods underperform when their underlying assumptions are lifted, as typically would occur in practical settings. By contrast, the experiments demonstrated that example generative model-based methods allow one to recover highly rewarding policies without such restrictive assumptions.

### Example Assumptions in Prior Slate Recommendation Methods

Decomposable Q-value (DQ): Example methods making this assumption are disclosed in Bai et al., A Model-Based Reinforcement Learning with Adversarial Training for Online Recommendation, in NeurIPS '19. 10734-10745; Chen et al., Top-K Off-Policy Correction for a REINFORCE Recommender System, In WSDM '19. 456-464; le et al., SlateQ: A Tractable Decomposition for Reinforcement Learning with Recommendation Sets, in IJCAI '19, 2592-2599; Sunehag et al., Deep Reinforcement Learning with Attention for Slate Markov Decision Processes with High-Dimensional States and Actions. arXiv:1512.01124 (2015). In the DQ assumption, future rewards are caused only by clicked items, allowing one to decompose the Q-values: Q^{π}(s,a)=Σ_{i∈a}P(cᵢ|s,a) Q^{exec}(s,i) with Q^{exec}(s,i) the expected future return (i.e., after the click) caused by the clicked item i.

Single click (1CL): This assumption is made in methods disclosed in Bai et al., A Model-Based Reinforcement Learning with Adversarial Training for Online Recommendation, in NeurlPS '19. 10734-10745; Chen et al., Top-K Off-Policy Correction for a REINFORCE Recommender System, In WSDM '19. 456-464; and le et al., SlateQ: A Tractable Decomposition for Reinforcement Learning with Recommendation Sets, in IJCAI '19. 2592-2599. In the 1CL assumption, users can click on at most one item per slate.

Mutual independence (MI): This assumption is made in Bai et al., A Model-Based Reinforcement Learning with Adversarial Training for Online Recommendation, in NeurIPS '19. 10734-10745; and in Chen et al., Top-K Off-Policy Correction for a REINFORCE Recommender System, In WSDM '19. 456-464; le et al., SlateQ: A Tractable Decomposition for Reinforcement Learning with Recommendation Sets, in IJCAI '19, 2592-2599. In the MI assumption, the returns of items in the same slate are mutually independent.

Sequential presentation (SP): This assumption is made in Sunehag et al., Deep Reinforcement Learning with Attention for Slate Markov Decision Processes with High-Dimensional States and Actions. arXiv:1512.01124 (2015): In the SP assumption, the true click model is top-down and fading, i.e., for l≤k the position of item i in slate a, P(c^{l}|s,a)=P(c^{l}|s,a_{≤l})≤P(c^{l}|s,ã_{≤l-1}), where a_{≤l}=(i¹, . . . , (i^{l-1},i) and ã_{≤l-1}=(i¹, . . . , i^{l-2},i). This assumption is used to ensure submodularity of the Q-function.

Knowledge of click model (CM): This assumption is used in SlateQ. True relevance and click probabilities are known. SlateQ leverages this assumption to perform planning inside this given model. Note that while the assumption SP constrains the user click model, the CM assumption also requires knowledge of its parameters, and is thus stronger.

Execution is best (EIB): This assumption is made in methods disclosed in Sunehag et al., Deep Reinforcement Learning with Attention for Slate Markov Decision Processes with High-Dimensional States and Actions. arXiv:1512.01124 (2015). In this assumption, recommendations which are risky on the short term are never worth it, i.e., for any policies π₁, π₂, (P(R(s,π₁ (s)=0)≥P(R(s,π₂(s)=0)⇒V^{π}^{₁}(s)≤V^{π}^{₂}(s)). Note that such an assumption partly defeats the purpose of long-term optimization.

Logged data availability (LD): This assumption is made in methods disclosed in Sunehag et al., Deep Reinforcement Learning with Attention for Slate Markov Decision Processes with High-Dimensional States and Actions. arXiv:1512.01124 (2015): Logged data from past interactions is available.

Methods according to example embodiments herein can also exploit the availability of logged data. As described above, for instance, an example recommender system can exploit the availability of logged data with slates and associated interactions (e.g., clicks). Such logged data can be readily available in common recommendation settings.

### Baselines and Their Assumptions

Baselines used in experiments will now be described. Example methods herein were evaluated against four main baselines derived from prior methods. These baselines as well as the assumptions on user behavior that they formulate are provided to make the combinatorial problem of slate recommendation tractable. By doing so, experiments can be used to compare the assumptions made by these baselines and highlight the generality of example method in Table 1.

SoftMax: Bai et al., A Model-Based Reinforcement Learning with Adversarial Training for Online Recommendation, in NeurIPS '19. 10734-10745; and Chen et al., Top-K Off-Policy Correction for a REINFORCE Recommender System, In WSDM '19. 456-464; and le et al., SlateQ: A Tractable Decomposition for Reinforcement Learning with Recommendation Sets, in IJCAI '19, 2592-2599, disclose methods in which the combinatorial problem of slate optimization is reduced to the simpler problem of item optimization. The policy network output is a SoftMax layer over all items in the collection, and items are sampled with replacement to form slates. Doing so requires the mild assumption that the Q-value of the slate can be linearly decomposed into item-specific Q-values. Additionally, this approach also requires two strong assumptions, namely that users can click on at most one item per slate (1CL); and the returns of items in the same slate are mutually independent (MI). Together, these assumptions are restrictive, because their conjunction means that the click probability of an item in the slate does not depend on the item itself. Indeed, having dependent click probabilities (to enforce the single click) and independent items in the slate is compatible only if click probabilities do not depend on items.

SlateQ: le et al., SlateQ: A Tractable Decomposition for Reinforcement Learning with Recommendation Sets, in IJCAI '19. 2592-2599 provides a model-based approach in which the click behavior of the user is given, and Q-learning, e.g., as disclosed in Christopher Watkins and Peter Dayan, Q-learning, Machine Learning 8 (1992), 279-292, is used to plan within this model and approximate users' dynamic preferences. In addition to the DQ and 1CL assumptions described above, this approach requires access to the true relevance and click model, which is an unfair advantage compared to other methods. For computational efficiency reasons, experiments herein adopted a faster variant referred to as QL-TT-TS.

TopK: This approach is included in the set of baselines as it is a natural way to deal with slate recommendation, though it is not believed to have been used in prior methods. The agent takes continuous actions in the space of item embeddings, and slates are generated by taking the k items from the collection with the closest embeddings to the action, according to a similarity metric (the dot-product in practice). This method therefore assumes the availability of logged data of past interactions (assumption LD), in order to pre-train item embeddings.

The experiments considered two variants of this baseline: 1) TopK (MF), where item embeddings are learned by matrix factorization, as disclosed in Koren et al., Matrix Factorization Techniques for Recommender Systems, Computer 42, 8 (2009), 30-37; and 2) TopK (ideal), which uses ideal item embeddings, i.e., the embeddings used internally by the simulator. The latter version clearly has an unfair advantage, especially since the relevance probability is also computed using the dot-product in the simulator. Also, because ranking items this way assumes that the most rewarding items should appear on top, it makes the sequential presentation (SP) assumption from Sunehag et al., Deep Reinforcement Learning with Attention for Slate Markov Decision Processes with High-Dimensional States and Actions. arXiv: 1512.01124 (2015), that the true click model is top-down and fading.

WkNN: Sunehag et al., Deep Reinforcement Learning with Attention for Slate Markov Decision Processes with High-Dimensional States and Actions. arXiv:1512.01124 (2015) discloses a finer-grained and potentially more capable variant of TopK referred to as Wolpertinger (see Dulac-Arnold et al., Deep Reinforcement Learning in Large Discrete Action Spaces, arXiv:1512.07679 (2015). Here, the agent takes actions in the product-space of item embeddings over slate slots, i.e., continuous actions of dimension k×d, where d is the dimension of item embeddings. Then, for each slot in the slate, p candidate items are selected by Euclidean distance with embeddings of items from the collection, and every candidate item's contribution to the Q-value is evaluated in a greedy fashion.

Besides the LD and DQ assumptions, WkNN requires two strong assumptions to ensure submodularity of the Q-function: sequential presentation (SP), and execution is best (EIB). As noted herein, this partly defeats the purpose of long-term optimization.

Table 1 summarizes the above assumptions made by each baseline. In comparison to prior work, example systems and methods provided herein (shown as “GeMS” in Table 1) need only rely on the availability of logged data with slates and associated clicks (LD), as Table 1 indicates. Such logged data is readily available in common industrial recommendation settings.

TABLE 1

| | 1CL | DQ | MI | CM | SP | EIB | LD |
|---|---|---|---|---|---|---|---|
| SoftMax [3, 8] | ✓ | ✓ | ✓ | X | X | X | X |
| SlateQ [18] | ✓ | ✓ | X | ✓ | X | X | X |
| WkNN [31] | X | ✓ | X | X | ✓ | ✓ | ✓ |
| TopK | X | X | X | X | ✓ | X | ✓ |
| GeMS (Ours) | X | X | X | X | X | X | ✓ |

In addition to these baselines, the experiments also included a random policy and a short-term oracle as reference points. The short-term oracle has access to the true user and item embeddings, enabling it to select the items with the highest relevance probability in each slate. Therefore, at each turn of interaction, it gives an upper bound on the immediate reward, but it is unable to cope with boredom and influence phenomena.

### Experimental Setup

Simulator: To illustrate example benefits and features, a simulator was designed which allowed observation of the effect of lifting the assumptions required by the baselines. Experiments were conducted using several variants of this simulator in order to demonstrate generalizability of example methods.

Item and User Embeddings: Following the example scenario (S) described herein, the simulator used in experiments includes 1,000 items. A cold-start situation was considered where users are generated on-the-fly for each new trajectory. Items and users are randomly assigned embeddings of size 20, corresponding to ten 2-dimensional topics: e=(e¹, . . . , e¹⁰). Each 2-dimensional vector e^{t} was meant to capture the existence of subtopics within topic t.

The embedding of a user or item x was generated using the following process: i) sample topic propensities wₓ^{t}˜ [symbol] (0,1) and normalize such that Σₜwₓ^{t}=1; ii) sample topic-specific components ϵₓ^{t}˜ [symbol] (0,0.4·I₂) and rescale as ϵₓ^{t}=wₓ^{t}·min (∥ϵₓ^{t}∥,1)); and iii) normalize the embedding ϵₓ=(ϵₓ¹, . . . , ϵₓ¹⁰) such that ∥eₓ∥=1. Each item is associated to a main topic, defined as

$$t ( i ) = arg {max}_{1 \leq l \leq 10} ‖ {e}_{i}^{t} ‖ .$$

To accommodate different types of content and platforms, two variants of item embeddings were derived in the simulator: one with embeddings obtained as described above, and one with embeddings for which we square and re-normalize each component. The difference in peakedness is highlighted by referring to the former as “diffuse embeddings” and the latter as “focused embeddings.”

Relevance computation: The relevance probability of item i for user u is a monotonically increasing function of the dot-product between their respective embeddings: rel(i,u)=σ(eᵢ^{T}eᵤ), where σ is a sigmoid function, such as a rescaled sigmoid function

$$σ ( x ) = \frac{1}{1 + exp ( - ( x - 0.28 ) \times 100 )} .$$

The example values were chosen sigmoid function because they satisfy three criteria:
A random policy almost always proposes irrelevant items;
An oracle policy always proposes relevant items; and
A bored user cannot be satisfied most of the time, even by an oracle policy.

Boredom and influence effects: User embeddings can be affected by mechanisms including boredom and influence. For instance, each item i clicked by user u influences the user embedding in the next interaction turn as: eᵤ←ωeᵤ+(1−ω))eᵢ. In an example, ω is set to ω=0.9. Additionally, if in the last 10 items clicked by user u five have the same main topic t^{b}, then u is deemed to get bored with this topic, meaning one put eᵤ^{t}^{^{b}}=0 for 5 turns. These mechanisms have been defined to penalize myopic behavior and encourage long-term strategies.

Click Model: Users click on recommended items according to a position-based model, i.e., the click probability is the product of item-specific attractiveness and rank-specific examination probabilities: P(c|i,r)=Aᵢ×Eᵣ. Specifically, one defines for an item located at rank r: Eᵣ=νε^{r}+(1−ν)ε^{k+1-r} with ε=0.85. It is a mixture of the terms ε^{r} and a^{k+1-r}, which respectively capture the top-down and bottom-up browsing behaviors.

Two variants of this click model were used in the experiments: TopDown with ν=1.0 and Mixed with ν=0.5. The attractiveness of an item is set to its relevance in TopDown and Mixed. In addition, a third variant is considered, DivPen, which also penalizes slates that lack diversity: Aᵢ is down-weighted by a factor of 3 if more than 4 items from the slate have the same main topic (as in Mixed, ν=0.5 is also set for DivPen).

In total, the experiments were performed on six simulator variants defined by the choice of item embedding peakedness (diffuse item embeddings or focused item embeddings) and the choice of click model (TopDown, Mixed, or DivPen).

### Implementation and Evaluation

The example implementations were configured to be as standard as possible to demonstrate reproducibility. All baselines were paired with SAC, as disclosed in Haarnoja et al., Soft Actor-Critic: Off-Policy Maximum Entropy Deep Reinforcement Learning with a Stochastic Actor. In ICML '18. 1856-1865, except SlateQ which is based on Q-Learning, as disclosed in C. Watkins and P. Dayan, Q-learning, Machine Learning 8 (1992), 279-292; and SoftMax, which was paired with REINFORCE, as disclosed in R. Sutton and A. Barto, 2018, Reinforcement Learning: An Introduction, MIT Press, 326-329, because it required a discrete action space and a discretized variant of SAC led to lower performance in experiments.

All agents were implemented using two-layer neural networks as function approximators, and used target networks for Q-functions in Slate-Q and SAC. For hyperparameters common to baselines and example methods, experiments first performed a grid search over likely regions of the space on baselines, and re-used the selected values for example method. For all methods the Adam optimizer was used with learning rates of 0.001 for Q-networks and 0.003 for policy networks when applicable, as well as a discount factor γ=0.8 and a polyak averaging parameter τ=0.002. For the hyperparameters specific to example methods (d, β and λ), a grid search was performed on the TopDown environment with focused item embeddings, and the combination with the highest validation return was selected. This combination was then re-used on all other environments. The searched ranges were defined as d∈{16,32}, β∈{0.1,0.2,0.5,1.0,2.0} and λ∈{0.0, 0.2, 0.5, 1.0}.

For methods making the (LD) assumption, a dataset was generated of 100K user trajectories (with 100 interactions turns each) from an ϵ-greedy oracle policy with ϵ=0.5, i.e., each recommended item is selected either uniformly randomly or by an oracle, with equal probabilities. The VAE in example generative model-based methods (GeMS) was trained on this dataset for 10 epochs with a batch size of 256 and a learning rate of 0.001. For approaches requiring pretrained item embeddings (TopK and WkNN), a simple matrix factorization model on the generated dataset was learned by considering as positive samples the pairs composed of the user in the trajectory and each clicked item in their recommended slates.

Evaluation protocol: In all experiments, the average cumulative rewards were compared over 10 seeded runs, corresponding to ten initializations of the agent's parameters. In the case of GeMS, the seed also controls the initialization of the VAE model during pre-training. Agents were trained for 100K steps. Each step corresponded to a user trajectory, composed of 100 interaction turns (i.e., 100 slates successively presented to the user) for a unique user. Every 1,000 training steps, experiments also evaluated the agents on 200 validation user trajectories. Finally, the agents were tested by selecting the checkpoint with the highest validation return and applying it on 500 test user trajectories. Confidence intervals use Student's t-distribution, and statistical tests are Welch's t-test. Both were based on a 95% confidence level.

Example slate recommender systems based on generative models of slates (GeMS methods) were compared to the baseline methods when the underlying assumptions of the latter methods are lifted. The experiments compared the performance of example GeMS-based methods to baselines on a wide array of simulated environments, corresponding to the six environments described above.

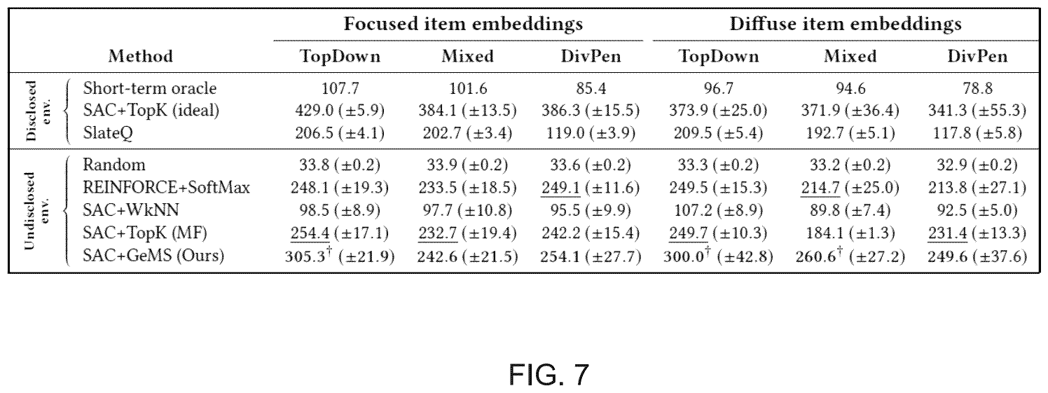

FIG. 7 shows the average test return (i.e., cumulated reward or cumulated number of clicks) after training on 100K user trajectories. Methods were grouped into two categories: “Disclosed env.,” i.e., methods leveraging hidden environment information, and “Undisclosed env.,” i.e., methods that consider the environment as a black-box and are therefore practically applicable.

Regardless of the specific environment used, the short-term oracle was easily beaten by most approaches. The experimental simulator penalizes short-sighted recommendations that lead to boredom. In these experimental environments, diversity is required to reach higher returns.

The superiority of SAC+TopK (Ideal) was not surprising, as this method benefits from an unfair advantage, namely access to true item embeddings. Likewise, example methods herein may be augmented with domain knowledge to improve their performance. However, despite having access to privileged information, SlateQ's performance was subpar, especially in DivPen environments, which may be due to its approximate optimization strategy and restrictive single-click assumption.

Comparison across methods: The example models incorporating SAC for RL and GeMS models (SAC+GeMS) compared favorably to baselines across the range of simulated environments. Out of the six tested environments, SAC+GeMS obtained the best average results on all of them, among which three show a statistically significant improvement over all other methods.

On the other hand, SAC+WkNN performed very poorly. This approach may suffer from the curse of dimensionality due to the larger action space (200 dimensions in the experiments) and the assumption made by the approach that candidate items need to be close to target item embeddings according to the Euclidean distance.

SAC+TopK (MF) was more competitive, but the large difference with SAC+TopK (ideal) suggests that TopK was very sensitive to the quality of item embeddings. Despite its very restrictive assumptions and lack of theoretical guarantees in the experimental setup, REINFORCE+SoftMax was a very competitive baseline overall. However, while its best checkpoint had high return, its training was unstable and failed to converge in the experiments, which suggests it may be unreliable. Generally, REINFORCE+SoftMax also suffers from its inability to scale to larger collections of items, which limits its practical applicability.

Comparisons across environments: The TopDown environment was the easiest for most methods, regardless of the type of item embeddings. This was not surprising as all methods besides Random either assumed a top-down click model, sample items in a top-down fashion, or rely on data from a top-down logging policy. However, other factors can dominate the performance, such as sub-optimality of item embeddings for SAC+TopK (MF).

Conversely, DivPen was harder for most methods, because the method requires a strong additional constraint to obtain high retums: intra-slate diversity must be high. SAC+GeMS was also affected by these dynamics, but remained able to beat other methods by generating diverse slates. The use of diffused item embeddings did not appear to cause lower returns for example GeMS models, compared with focused ones, though it was associated with larger confidence intervals for SAC+GeMS. Pivot items spanning multiple topics were more likely to be attractive, at the expense of more fine-grained strategies.

### Effect of Balancing Immediate and Future Rewards

As described above, long-term optimization with RL can penalize myopic behavior such as recommending only highly relevant but similar items, which may lead to boredom. The experiments demonstrated that example methods such as SAC+GeMS were able to adapt its slate selection to cope with boredom. In the simulated environments, users would get bored of a particular topic whenever 5 of their latest 10 clicks were on items from that topic. When a topic was saturated, its corresponding dimensions in the user embedding were set to 0, which has the effect of diminishing the attractiveness of future items presented to the user. This scenario makes it therefore beneficial to avoid boredom to reach higher returns, even if it comes at the cost of lower immediate rewards.

Experiments compared three approaches on the TopDown environment with focused item embeddings: The short-term oracle (STO) always maximizing the immediate reward; SAC+GeMS with γ=0.8 (an example of an embodiment method) where γ is the discount factor of the RL algorithm; and SAC+GeMS with γ=0, which does not explicitly include future rewards in its policy gradient. In this environment, SAC+GeMS^{γ=0.8} achieves an average test return of 305.3, while SAC+GeMS^{γ=0} reaches 194.3, and STO only obtains 107.7. These results suggest that long-term optimization is indeed required to reach higher returns. It may seem surprising that SAC+GeMS^{γ=0} gets better returns than STO, but its training objective incentivizes average immediate rewards, which implicitly encourages it to avoid low future rewards. However, adopting an explicit mechanism to account for its causal effect on the user (i.e., setting γ=0.8) allows SAC+GeMS to improve its decision-making.

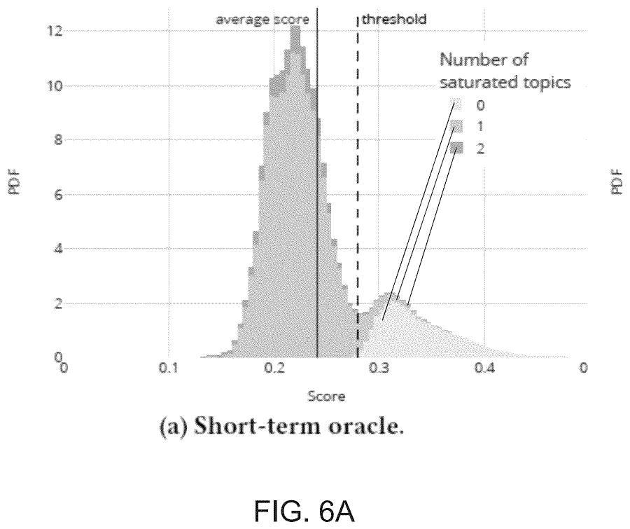

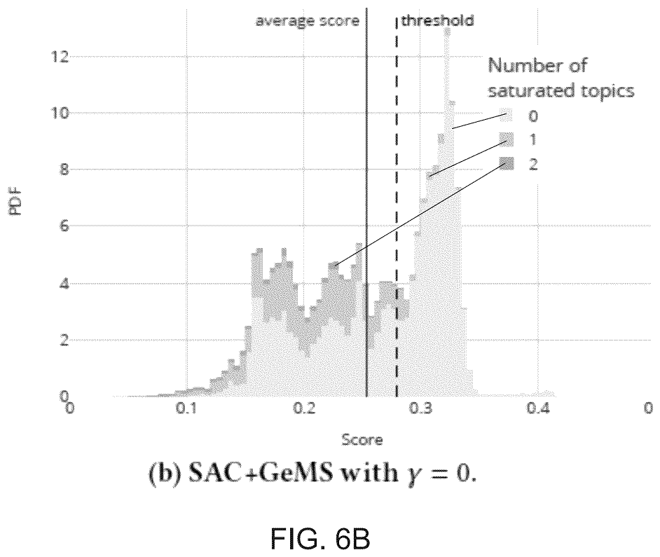

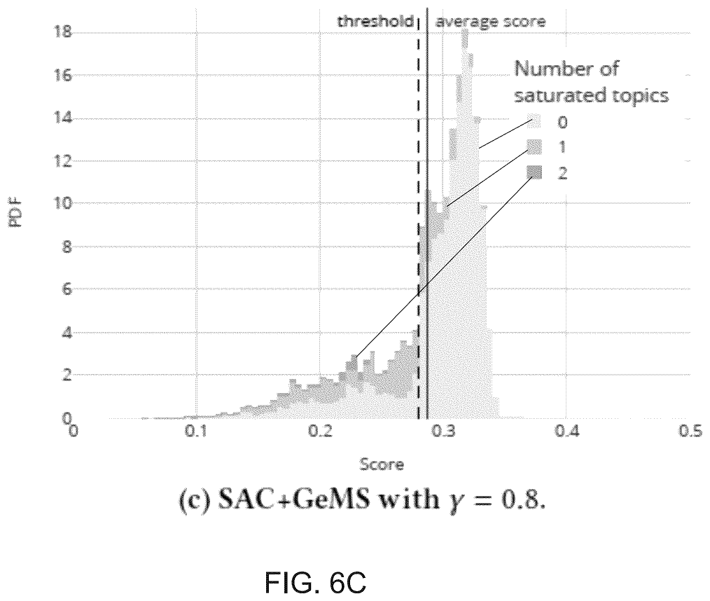

FIGS. 6A-6C illustrate the distribution of item scores (i.e., the dot-product between internal user and item embeddings as defined herein) for the items recommended in slates by each of the three methods, with the same seed for all three plots. The dashed vertical line shows the score threshold of 0.28 needed to reach a relevance probability of 0.5. Therefore, items on the left of this line had a lower click probability while items on the right had a higher click probability. The color (or shade) indicates how many topics were saturated when the agent recommended that particular item whose score is plotted: it can be seen that when the user is bored of at least one topic, items become less attractive as scores are reduced.

When no topic was saturated (i.e., yellow (lighter) distribution), STO (FIG. 6A) recommended items with excellent scores (above the threshold and up to 0.45): as a consequence, STO received high immediate rewards. However, by doing so it incurred a lot of boredom (large orange areas). Overall, it led to lower expected scores (solid red (dark vertical) line) and therefore fewer clicks.

Conversely, SAC+GeMS^{γ=0.8} (FIG. 6C) sacrificed some immediate reward (yellow (lighter) distribution shifted to the left) but caused very little boredom (small orange (darker) area). Overall, by trading off relevance and diversity, SAC+GeMS^{γ=0.8} yielded good immediate rewards while limiting boredom. It therefore received higher average scores. SAC+GeMS^{γ=0} (FIG. 6B) exhibited an intermediate behavior due to its limited capabilities: it recommends items of varying relevance, yet leads to substantial boredom (larger orange area than for γ=0.8).

### Effect of Balancing Hyperparameters β and λ in GeMS on Downstream RL Performance

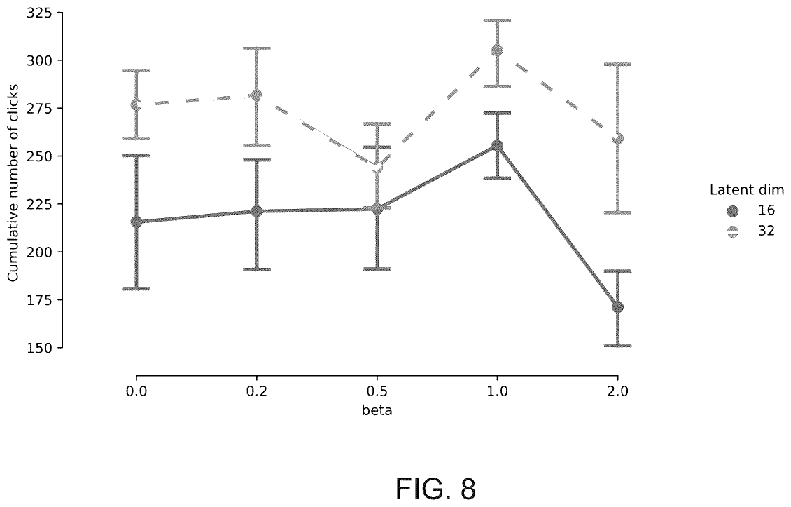

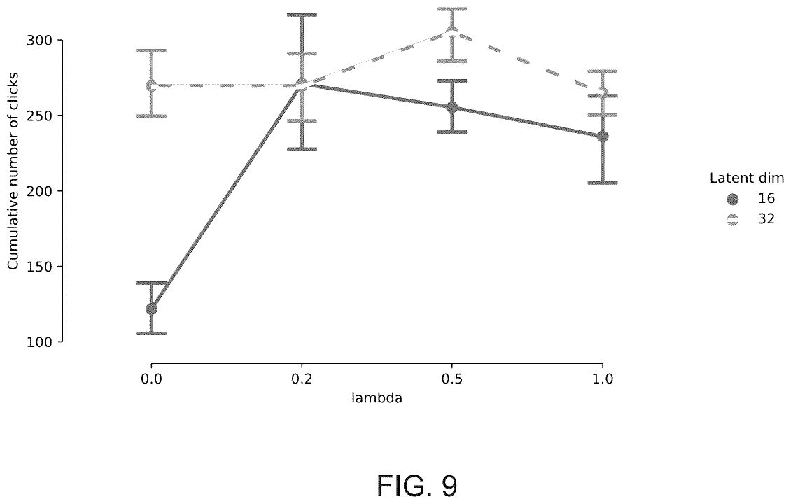

The choice of β and λ may lead to trade-offs that in turn may impact the downstream performance of SAC+GeMS. In an example generative model pretraining, β adjusts the importance of accurate reconstruction versus smoothness and structure in the latent space (i.e., controllability), while λ weights the click reconstruction with respect to the slate reconstruction. Experiments assessed the importance of these trade-offs by illustrating in FIGS. 8-9 the best validation return obtained for different values of these hyperparameters, on the TopDown environment with focused item embeddings.

FIG. 8 suggests that there was a sharp trade-off controlled by β, and that there may exist an optimal range in the selection of β. Thus, it may be useful to appropriately balance B to improve performance on the downstream RL task. In the experiments, it was found that choosing β=1.0 led to the highest return overall, regardless of whether a latent dimension of 16 or 32 is used.

The impact on the downstream performance of the trade-off between slate and click reconstruction shown in FIG. 9 was less prominent but can still be observed. The results illustrate benefits of including the click reconstruction term in the pretraining loss (Eq. (2)), even though clicks output by GeMS' decoder were not used during RL training. Results also illustrate benefits of introducing and adjusting the hyperparameter λ: modeling clicks jointly with slates improved the final performance of SAC+GeMS, but properly weighting the click reconstruction objective with respect to the slate reconstruction objective provided further improvements.

Experiments across a wide array of environments demonstrated that example methods based on generative modeling of slates compared favorably against existing slate representation methods in practical settings. Moreover, it was shown that example methods can effectively balance immediate and future rewards. Introducing and properly balancing hyperparameters β and A may further improve the RL downstream performance. Example methods incorporating variational auto-encoders for slate recommendation with reinforcement learning are flexible, allowing full-slate modeling and lightweight assumptions, in contrast with existing approaches.

### Network Architecture

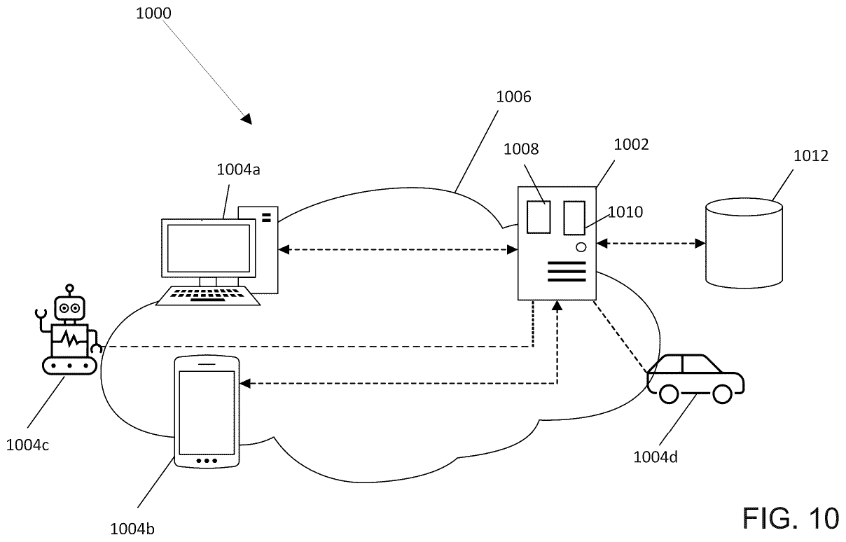

Example systems, methods, and embodiments may be implemented within a network architecture 1000 such as illustrated in FIG. 10, which comprises a server 1002 and one or more client devices 1004 that communicate over a network 1006 which may be wireless and/or wired, such as the Internet, for data exchange. The server 1002 and the client devices 1004a, 1004b can each include a processor, e.g., processor 1008 and a memory, e.g., memory 1010 (shown by example in server 1002), such as but not limited to random-access memory (RAM), read-only memory (ROM), hard disks, solid state disks, or other non-volatile storage media. Memory 1010 may also be provided in whole or in part by external storage in communication with the processor 1008.

The content recommendation platform 100 (shown in FIG. 1) and/or the recommender system 200 (shown in FIG. 2), for instance, may be embodied in the server 1002 and/or client devices 1004. It will be appreciated that the processor 1008 can include either a single processor or multiple processors operating in series or in parallel, and that the memory 1010 can include one or more memories, including combinations of memory types and/or locations. Server 1002 may also include, but are not limited to, dedicated servers, cloud-based servers, or a combination (e.g., shared). Storage, e.g., a database, may be embodied in suitable storage in the server 1002, client device 1004, a connected remote storage 1012 (shown in connection with the server 1002, but can likewise be connected to client devices), or any combination.

Client devices 1004 may be any processor-based device, terminal, etc., and/or may be embodied in a client application executable by a processor-based device, etc. Client devices may be disposed within the server 1002 and/or external to the server (local or remote, or any combination) and in communication with the server. Example client devices 1004 include, but are not limited to, autonomous computers 1004a, mobile communication devices (e.g., smartphones, tablet computers, etc.) 1004b, robots 1004c, autonomous vehicles 1004d, wearable devices, virtual reality, augmented reality, or mixed reality devices (not shown), or others. Client devices 1004 may be configured for sending data to and/or receiving data from the server 1002, and may include, but need not include, one or more output devices, such as but not limited to displays, printers, etc. for displaying or printing results of certain methods that are provided for display by the server. Client devices may include combinations of client devices.

In an example training method, such as a pretraining method for the generative model, the server 1002 or client devices 1004 may receive a dataset such as the dataset described herein from any suitable source, e.g., from memory 1010 (as nonlimiting examples, internal storage, an internal database, etc.), from external (e.g., remote) storage 1012 connected locally or over the network 1006. The example pretraining method can generate a trained generative model that can be likewise stored and/or incorporated in whole or in part with the RL-based recommender system in the server (e.g., memory 1010), client devices 1004, external storage 1012, or combination. In some example embodiments provided herein, training (including pretraining or RL agent training) and/or operation of the recommender system or the content recommendation platform may be performed offline or online (e.g., at run time), in any combination. Results can be output (e.g., displayed, transmitted, provided for display, printed, provided for speech, provided for delivery by a virtual assistant or bot, etc.) and/or stored for retrieving and providing on request.

In an example recommendation method the server 1002 or client devices 1004 may receive a query 102 from any suitable source, e.g., by local or remote input from a suitable interface, or from another of the server or client devices connected locally or over the network 1006 and process the query using example neural models (or by a more straightforward tokenization, in some example methods). Models such as the example retriever 104 and/or recommender system 108, 200 including ranker 204 can be likewise stored in the server (e.g., memory 1010), client devices 1004, external storage 1012, or combination. Results can be output (e.g., displayed, transmitted, provided for display, printed, provided for speech, provided for delivery by a virtual assistant or bot, etc.) and/or stored for retrieving and providing on request.

Generally, embodiments can be implemented as computer program products with a program code or computer-executable instructions, the program code or computer-executable instructions being operative for performing one of the methods when the computer program product runs on a computer. The program code or the computer-executable instructions may, for example, be stored on a computer-readable storage medium.

In an embodiment, a storage medium (or a data carrier, or a computer-readable medium) comprises, stored thereon, the computer program or the computer-executable instructions for performing one of the methods described herein when it is performed by a processor.

Embodiments described herein may be implemented in hardware or in software. The implementation can be performed using a non-transitory storage medium such as a computer-readable storage medium, for example a floppy disc, a DVD, a Blu-Ray, a CD, a ROM, a PROM, and EPROM, an EEPROM or a FLASH memory. Such computer-readable media can be any available media that can be accessed by a general-purpose or special-purpose computer system.

### General

Embodiments of the present invention provide, among other things, a method of training a recommender system implemented by a processor and memory to recommend a slate of items from a collection to a user, the method comprising pretraining a neural network-based decoder to generate a slate of items from a representation in a continuous low-dimensional latent space; and training a reinforcement learning agent in the recommender system to determine an action in the latent space, the action representing a recommended slate of items from the collection based on a state; wherein the recommender system comprises the pretrained decoder for generating the recommended slate of items from the action determined by the agent. In addition to any of the above features in this paragraph, the pretraining of the decoder may comprise pretraining a generative model comprising the decoder and a neural network-based encoder. In addition to any of the above features in this paragraph, the generative model may comprise a variational autoencoder (VAE). In addition to any of the above features in this paragraph, said pretraining of the generative model may comprise training the decoder to reconstruct the slate of items from a representation in the latent space of a combination of the slate of items and a set of interactions associated with the slate of items. In addition to any of the above features in this paragraph, interactions in the set of interactions may be respectively associated with items in the slate of items. In addition to any of the above features in this paragraph, the interactions may comprise selections among the items in the slate; wherein the set of interactions may comprise a vector indicating whether the items in the slate were selected or not selected. In addition to any of the above features in this paragraph, the set of interactions may indicate that a plurality of items in the slate was selected. In addition to any of the above features in this paragraph, the interactions may comprise user clicks. In addition to any of the above features in this paragraph, the pretraining of the generative model may comprise learning a joint distribution over slates of items, associated sets of interactions, and latent representations. In addition to any of the above features in this paragraph, the pretraining of the generative model may use a dataset comprising a plurality of logged interactions. In addition to any of the above features in this paragraph, the plurality of logged interactions may comprise a plurality of data pairs, each data pair comprising a slate of items and an associated set of interactions. In addition to any of the above features in this paragraph, the dataset may be generated offline. In addition to any of the above features in this paragraph, the dataset may be based on prior interactions with the user. In addition to any of the above features in this paragraph, the dataset may be generated based on prior interactions at least partially with users other than the user. In addition to any of the above features in this paragraph, pretraining of the generative model may further comprise: sampling a data pair from the dataset; and embedding the items in the slate from the sampled data pair; wherein the latent representation of the slate may comprise a vector having a dimension d, and wherein a combination of the embedded items from the slate may comprise a vector having a dimension greater than d. In addition to any of the above features in this paragraph, the item embeddings may be learnable. In addition to any of the above features in this paragraph, the pretraining of the generative model further may comprise: combining the embedded items from the slate with the associated set of interactions. In addition to any of the above features in this paragraph, said combining may comprise concatenating the embedded items from the slate with the associated set of interactions. In addition to any of the above features in this paragraph, the generative model may generate the latent representation using the combined embedded items from the slate and associated set of interactions. In addition to any of the above features in this paragraph, said generation of the latent representation may further comprise an encoder neural network of the encoder encoding the combined embedded items from the slate and associated set of interactions; wherein the encoder neural network may be modeled by a first set of parameters. In addition to any of the above features in this paragraph, generating the latent representation may further comprise: computing a posterior probability distribution from a prior probability distribution over the latent space, the posterior probability distribution corresponding to the embedded items from the slate and associated set of interactions; and generating the latent representation using the posterior probability distribution. In addition to any of the above features in this paragraph, the prior probability distribution may comprise a Gaussian distribution. In addition to any of the above features in this paragraph, the pretraining of the generative model may further comprise: the decoder decoding the generated latent representation to reconstruct the slate of items and the associated set of interactions; wherein the decoder may comprise a neural network having a second set of parameters. In addition to any of the above features in this paragraph, the reconstruction of the slate of items may comprise: reconstructing the embedded items from the slate; and generating the reconstructed slate of items from the reconstructed embeddings. In addition to any of the above features in this paragraph, the generation of the reconstructed slate of items may comprise: deriving logits for a set of item probabilities from the reconstructed embeddings; and generating the reconstructed slate of items from the derived logits. In addition to any of the above features in this paragraph, the pretraining of the generative model may further comprise: reconstructing the associated set of interactions. In addition to any of the above features in this paragraph, said training the generative model may further comprise: updating the first and second sets of parameters using the reconstructed slate of items and the reconstructed associated set of interactions to optimize a loss function. In addition to any of the above features in this paragraph, the updating of the first and second sets of parameters may take place for one of each sampled data pair. In addition to any of the above features in this paragraph, the updating of the first and second sets of parameters may take place for a batch of sampled data pairs. In addition to any of the above features in this paragraph, the updating of the first and second sets of parameters may take place for all of the data pairs in the dataset. In addition to any of the above features in this paragraph, optimizing the loss function may comprise maximizing an evidence lower bound (ELBO) on a task of reconstructing slates of items and associated sets of interactions. In addition to any of the above features in this paragraph, the loss function may comprise: a slate reconstruction loss; a set of interactions reconstruction loss; and a prior matching loss. In addition to any of the above features in this paragraph, the slate reconstruction loss, the set of interactions reconstruction loss, and/or the prior matching loss may be weighted by a hyperparameter. In addition to any of the above features in this paragraph, the prior matching loss may comprise a Kullback-Leibler divergence. In addition to any of the above features in this paragraph, the items may comprise identifiers respectively associated with items in the collection. In addition to any of the above features in this paragraph, the items in the collection may comprise media items, documents, terms, tokens, news articles, e-commerce products, or a combination. In addition to any of the above features in this paragraph, the training of the reinforcement learning agent may take place while the pretrained decoder is integrated into the recommender system, and while the pretrained decoder is frozen. In addition to any of the above features in this paragraph, the recommender system outputs the recommended slate to the user. In addition to any of the above features in this paragraph, the reinforcement learning agent may determine the state based on observed interactions from the user. In addition to any of the above features in this paragraph, the recommender system may further comprise a belief encoder for determining the state based on observed interactions from the user. In addition to any of the above features in this paragraph, the belief encoder may be modeled by a gated recurrent unit (GRU). In addition to any of the above features in this paragraph, the reinforcement learning agent may comprise an actor-critic algorithm. In addition to any of the above features in this paragraph, the reinforcement learning agent may be defined by a policy; and the training of the reinforcement learning agent may update the policy to improve a return. In addition to any of the above features in this paragraph, the recommender system may be configured to interact with the user throughout an episode of turns; wherein in each turn the recommender system may recommend a slate of items and the user interacts with one or more of the recommended slate of items; wherein the return may be determined based on a reward over the episode of turns. In addition to any of the above features in this paragraph, the reward may be based on a cumulative number of interactions by the user over the episode. In addition to any of the above features in this paragraph, training of a reinforcement learning agent may comprise a plurality of policy evaluation and policy improvement steps. In addition to any of the above features in this paragraph, the policy evaluation step may comprise evaluating a Q-function of an optimal policy; and the policy improvement step may comprise ϵ-greedily maximizing the estimated Q-function. In addition to any of the above features in this paragraph, the policy evaluation step may comprise estimating an expected return of a current policy; and the policy improvement step may comprise using gradient ascent on the estimated expected return.

According to additional embodiments, a method for providing a slate of items to a user may comprise determining, by an agent comprising a neural network based reinforcement learning model, an action in a continuous low-dimensional latent space, the action representing a slate of items from the collection being recommended based on a state, the state being based on observed interactions received from the user; receiving the action by a ranker may comprise a neural network-based decoder; generating, by the ranker, a recommended slate of items from the received action; and outputting the recommended slate of items to the user; wherein the decoder may comprise a decoder of a pretrained variational autoencoder, the autoencoder being pretrained to optimize a loss function may comprise a slate reconstruction loss for slates of items, a reconstruction loss for sets of interactions associated with the reconstruction loss, and a prior matching loss; wherein the agent is trained to improve a return based on a reward function while the decoder of the trained autoencoder is frozen. In addition to any of the above features in this paragraph, the interactions may comprise selections among the items in the slate; and the set of interactions may indicate whether the items in the slate were selected or not selected; wherein the autoencoder may be trained using a dataset may comprise slates of items and associated sets of interactions. In addition to any of the above features in this paragraph, the decoder may reconstruct embedded items from the slate and generate the reconstructed slate of items from the reconstructed item embeddings.

According to additional embodiments, a recommender system implemented by a processor and memory to recommend a slate of items from a collection to a user may comprise: a reinforcement learning agent trained to determine an action in a low-dimensional latent space, the action representing a slate of items from the collection being recommended based on a state, the state being based on observed interactions received from the user; and a ranker comprising a neural network based decoder pretrained to generate a recommended slate of items from the determined action and output the recommended slate of items to the user; wherein the decoder comprises a decoder of a pretrained variational autoencoder. In addition to any of the above features in this paragraph, the decoder may be pretrained to reconstruct a slate of items from a representation in the latent space of a combination of the slate of items and a set of interactions associated with the slate of items; wherein interactions in the set of interactions may be respectively associated with items in the slate of items. In addition to any of the above features in this paragraph, the interactions may comprise selections among the items in the slate; wherein the set of interactions may comprise a vector indicating whether the items in the slate were selected or not selected, and the set of interactions may indicate that a plurality of items in the slate was selected. In addition to any of the above features in this paragraph, the interactions may comprise user clicks. In addition to any of the above features in this paragraph, the autoencoder may be trained using a dataset may comprise a plurality of logged interactions; and the plurality of logged interactions may comprise a plurality of data pairs, each data pair comprising a slate of items and an associated set of interactions. In addition to any of the above features in this paragraph, the autoencoder may comprise the decoder and a neural network-based encoder; wherein the encoder is modeled by a first set of parameters; and wherein the decoder is modeled by a second set of parameters. In addition to any of the above features in this paragraph, the autoencoder may be trained by updating the first and second sets of parameters to optimize a loss function. In addition to any of the above features in this paragraph, the decoder may decode the action to reconstruct embedded items from the slate; wherein the decoder generates the reconstructed slate of items from the reconstructed item embeddings. In addition to any of the above features in this paragraph, the decoder may derive logits for a set of item probabilities from the reconstructed embeddings and generates the reconstructed slate of items from the derived logits. In addition to any of the above features in this paragraph, optimizing the loss function may comprise maximizing an evidence lower bound (ELBO) on a task of reconstructing slates of items and associated sets of interactions. In addition to any of the above features in this paragraph the loss function may comprise: a slate reconstruction loss; a set of interactions reconstruction loss; and a prior matching loss; wherein the slate reconstruction loss, the set of interactions reconstruction loss, and/or the prior matching loss are weighted by a hyperparameter. In addition to any of the above features in this paragraph, the items may comprise identifiers respectively associated with items in the collection; wherein the items in the collection comprise media items, documents, terms, tokens, news items, e-commerce items, or a combination. In addition to any of the above features in this paragraph, the agent may be trained while the trained decoder is integrated into the recommender system, and while the trained decoder is frozen. In addition to any of the above features in this paragraph, the recommender system may further comprise: a belief encoder configured to determine the state based on observed interactions from the user. In addition to any of the above features in this paragraph, the belief encoder may be modeled by a gated recurrent unit (GRU). In addition to any of the above features in this paragraph, the agent may be modeled by an actor-critic algorithm. In addition to any of the above features in this paragraph, the reinforcement learning agent may be defined by a policy; and training of the reinforcement learning agent updates the policy to improve a retum; wherein the recommender system is configured to interact with the user throughout an episode of turns; wherein in each turn the recommender system recommends a slate of items and the user interacts with one or more of the recommended slate of items; and wherein the return is determined based on a reward over the episode of turns. In addition to any of the above features in this paragraph, the reward may be based on a cumulative number of interactions by the user over the episode. In addition to any of the above features in this paragraph, the recommender system may be embodied in a second stage of a two-stage information retrieval system; and the information retrieval system may further comprise a first stage for retrieving a collection of items in response to a request.

According to additional embodiments, a variational autoencoder implemented by a processor and a memory comprises: an encoder trained to generate a representation in a low-dimensional latent space of a combination of a slate of items from a collection and a set of interactions associated with the slate of items, said encoder comprising a neural network defined by a first set of parameters; and a decoder trained with said encoder to reconstruct the slate of items and the set of interactions associated with the slate of items from a received representation in the latent space, said decoder comprising a neural network defined by a second set of parameters; the trained decoder being configured to receive an action in the latent space from a reinforcement learning agent, the action representing a slate of items from the collection being recommended to a user based on a state, the state being determined based on observed interactions from the user; and the trained decoder being further configured to generate a recommended slate of items from the received action and output the recommended slate of items to the user. In addition to any of the above features in this paragraph, the interactions may comprise selections among the items in the slate; wherein the set of interactions may comprise a vector indicating whether the items in the slate were selected or not selected; and the set of interactions may indicate that a plurality of items in the slate was selected. In addition to any of the above features in this paragraph, the interactions may comprise user clicks. In addition to any of the above features in this paragraph, the encoder and the decoder may be trained to learn a joint distribution over slates of items, associated sets of interactions, and latent representations. In addition to any of the above features in this paragraph, the encoder and the decoder may be trained using a dataset comprising a plurality of logged interactions; wherein the plurality of logged interactions comprises a plurality of data pairs, each data pair comprising a slate of items and an associated set of interactions. In addition to any of the above features in this paragraph, the items may comprise items in the collection or identifiers respectively associated with items in the collection; and the items in the collection may comprise media items, documents, terms, tokens, news items, e-commerce items, or a combination thereof. In addition to any of the above features in this paragraph, generating the recommended slate of items may comprise: deriving logits for a set of item probabilities from the reconstructed embeddings; and generating the recommended slate of items from the derived logits. In addition to any of the above features in this paragraph, the encoder and the decoder may be trained to optimize a loss function, wherein the loss function comprises: a slate reconstruction loss; a set of interactions reconstruction loss; and a prior matching loss; wherein the slate reconstruction loss, the set of interactions reconstruction loss, and/or the prior matching loss are weighted by a hyperparameter. In addition to any of the above features in this paragraph, the items may comprise identifiers respectively associated with items in the collection; and the items in the collection may comprise media items, documents, or a combination. In addition to any of the above features in this paragraph, the agent may be trained while the trained generative model is integrated into the recommender system, and while the trained generative model is frozen.

Additional embodiments of the invention provide, among other things, an apparatus for training a recommender system implemented by a processor and memory to recommend a slate of items from a collection to a user, the apparatus comprising: a non-transitory computer-readable medium having executable instructions stored thereon for causing a processor and a memory to: train a generative model to generate a slate of items from a representation in a low-dimensional latent space; and train an agent of a reinforcement learning model in the recommender system that is connected to the trained generative model to determine an action in the latent space, the action representing a slate of items recommended to the user from the collection based on a state; wherein the trained generative model generates the recommended slate of items from the determined action.

The foregoing description is merely illustrative in nature and is in no way intended to limit the disclosure, its application, or uses. The broad teachings of the disclosure may be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure may be implemented in and/or combined with features of any of the other embodiments, even if that combination is not explicitly described. In other words, the described embodiments are not mutually exclusive, and permutations of one or more embodiments with one another remain within the scope of this disclosure.

Each module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module. Each module may be implemented using code. The term code, as used above, may include software, firmware, and/or microcode, and may refer to programs, routines, functions, classes, data structures, and/or objects.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The systems and methods described in this application may be partially or fully implemented by a special purpose computer created by configuring a general purpose computer to execute one or more particular functions embodied in computer programs. The functional blocks, flowchart components, and other elements described above serve as software specifications, which may be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

It will be appreciated that variations of the above-disclosed embodiments and other features and functions, or alternatives thereof, may be desirably combined into many other different systems or applications. Also, various presently unforeseen or unanticipated alternatives, modifications, variations, or improvements therein may be subsequently made by those skilled in the art which are also intended to be encompassed by the description above and the following claims.

1-80. (canceled)

81. A method of training a recommender system implemented by a processor and memory to recommend a slate of items from a collection to a user, the method comprising:
pretraining a neural network-based decoder to generate a slate of items from a representation in a continuous low-dimensional latent space;
training a reinforcement learning agent in the recommender system to determine an action in the latent space, the action representing a recommended slate of items from the collection based on a state;
wherein the recommender system comprises the pretrained decoder for generating the recommended slate of items from the action determined by the agent.

82. The method of claim 81, wherein
said pretraining of the decoder comprises pretraining a generative model comprising the decoder and a neural network-based encoder;
the generative model comprises a variational autoencoder (VAE);
said pretraining of the generative model comprises training the decoder to reconstruct the slate of items from a representation in the latent space of a combination of the slate of items and a set of interactions associated with the slate of items; and
interactions in the set of interactions are respectively associated with items in the slate of items.

83. The method of claim 82, wherein the interactions comprise selections among the items in the slate;
wherein the set of interactions (i) comprises a vector indicating whether the items in the slate were selected or not selected, (ii) indicates that a plurality of items in the slate were selected or not selected, and (iii) comprise user clicks.

84. The method of claim 82, wherein said pretraining of the generative model (i) comprises learning a joint distribution over slates of items, associated sets of interactions, and latent representations; (ii) uses a dataset comprising a plurality of logged interactions which comprise a plurality of data pairs, each data pair comprising a slate of items and an associated set of interactions.

85. The method of claim 82, wherein the dataset is generated (i) offline, (ii) based on prior interactions with the user, and (iii) based on prior interactions at least partially with users other than the user.

86. The method of claim 82, wherein said pretraining of the generative model further comprises:
sampling a data pair from the dataset; and
embedding the items in the slate from the sampled data pair;
wherein the latent representation of the slate comprises a vector having a dimension d, and wherein a combination of the embedded items from the slate comprises a vector having a dimension greater than d.

87. The method of claim 86, wherein the item embeddings are learnable.

88. The method of claim 86, wherein said pretraining of the generative model further comprises:
combining the embedded items from the slate with the associated set of interactions; said combining comprises concatenating the embedded items from the slate with the associated set of interactions; and
the generative model generating the latent representation using the combined embedded items from the slate and associated set of interactions;
wherein said generation of the latent representation further comprises an encoder neural network of the encoder encoding the combined embedded items from the slate and associated set of interactions; and
wherein the encoder neural network is modeled by a first set of parameters.

89. The method of claim 88, wherein said generating the latent representation further comprises:
computing a posterior probability distribution from a prior probability distribution over the latent space, the posterior probability distribution corresponding to the embedded items from the slate and associated set of interactions; and
generating the latent representation using the posterior probability distribution; and
wherein the prior probability distribution comprises a Gaussian distribution.

90. The method of claim 88, wherein said pretraining of the generative model further comprises:
the decoder decoding the generated latent representation to reconstruct the slate of items and the associated set of interactions;
wherein the decoder comprises a neural network having a second set of parameters.

91. The method of claim 90, wherein said reconstruction of the slate of items comprises:
reconstructing the embedded items from the slate; and
generating the reconstructed slate of items from the reconstructed embeddings.

92. The method of claim 91, wherein said generation of the reconstructed slate of items comprises:
deriving logits for a set of item probabilities from the reconstructed embeddings; and
generating the reconstructed slate of items from the derived logits.

93. The method of claim 92, wherein said pretraining of the generative model further comprises:
reconstructing the associated set of interactions; and
wherein said training the generative model further comprises:
updating the first and second sets of parameters using the reconstructed slate of items and the reconstructed associated set of interactions to optimize a loss function.

94. The method of claim 93, wherein said updating of the first and second sets of parameters takes place for one of each sampled data pair; a batch of sampled data pairs, and all of the data pairs in the dataset.

95. The method of claim 93, wherein optimizing the loss function comprises maximizing an evidence lower bound (ELBO) on a task of reconstructing slates of items and associated sets of interactions.

96. The method of claim 93, wherein the loss function comprises:
a slate reconstruction loss;
a set of interactions reconstruction loss; and
a prior matching loss; and
wherein the slate reconstruction loss, the set of interactions reconstruction loss, and/or the prior matching loss are weighted by a hyperparameter; and
wherein the prior matching loss comprises a Kullback-Leibler divergence.

97. The method of claim 81, wherein said items comprise identifiers respectively associated with items in the collection; and wherein the items in the collection comprise media items, documents, terms, tokens, news articles, e-commerce products, or a combination.

98. The method of claim 81, wherein said training of the reinforcement learning agent takes place while the pretrained decoder is integrated into the recommender system, and while the pretrained decoder is frozen.

99. The method of claim 81, wherein the recommender system outputs the recommended slate to the user; and wherein the reinforcement learning agent determines the state based on observed interactions from the user.

100. The method of claim 81, wherein the recommender system further comprises (i) a belief encoder for determining the state based on observed interactions from the user; (ii) the belief encoder is modeled by a gated recurrent unit (GRU); and (iii) the reinforcement learning agent comprises an actor-critic algorithm.

101. The method of claim 81, wherein the reinforcement learning agent is defined by a policy; and
wherein said training of the reinforcement learning agent updates the policy to improve a return.

102. The method of claim 101, wherein the recommender system is configured to interact with the user throughout an episode of turns;
wherein in each turn the recommender system recommends a slate of items and the user interacts with one or more of the recommended slate of items;
wherein the return is determined based on a reward over the episode of turns;
wherein the reward is based on a cumulative number of interactions by the user over the episode; and
wherein said training of a reinforcement learning agent comprises a plurality of policy evaluation and policy improvement steps.

103. The method of claim 102, wherein the policy evaluation step comprises evaluating a Q-function of an optimal policy; and
wherein the policy improvement step comprises ϵ-greedily maximizing the estimated Q-function.

104. The method of claim 102, wherein the policy evaluation step comprises estimating an expected return of a current policy; and
wherein the policy improvement step comprises using gradient ascent on the estimated expected return.

105. A method for providing a slate of items to a user, the method comprising:
determining, by an agent comprising a neural network based reinforcement learning model, an action in a continuous low-dimensional latent space, the action representing a slate of items from the collection being recommended based on a state, the state being based on observed interactions received from the user;
receiving the action by a ranker comprising a neural network-based decoder;
generating, by the ranker, a recommended slate of items from the received action; and
outputting the recommended slate of items to the user;
wherein the decoder comprises a decoder of a pretrained variational autoencoder, the autoencoder being pretrained to optimize a loss function comprising a slate reconstruction loss for slates of items, a reconstruction loss for sets of interactions associated with the reconstruction loss, and a prior matching loss;
wherein the agent is trained to improve a return based on a reward function while the decoder of the trained autoencoder is frozen.

106. The method of claim 105, wherein the interactions comprise selections among the items in the slate; and
wherein the set of interactions indicate whether the items in the slate were selected or not selected;
wherein the autoencoder is trained using a dataset comprising slates of items and associated sets of interactions.

107. The method of claim 106, wherein the decoder reconstructs embedded items from the slate and generates the reconstructed slate of items from the reconstructed item embeddings.

108. A recommender system implemented by a processor and memory to recommend a slate of items from a collection to a user, the recommender system comprising:
a reinforcement learning agent trained to determine an action in a low-dimensional latent space, the action representing a slate of items from the collection being recommended based on a state, the state being based on observed interactions received from the user; and
a ranker comprising a neural network based decoder pretrained to generate a recommended slate of items from the determined action and output the recommended slate of items to the user;
wherein the decoder comprises a decoder of a pretrained variational autoencoder.

109. The recommender system of claim 108, wherein the decoder is pretrained to reconstruct a slate of items from a representation in the latent space of a combination of the slate of items and a set of interactions associated with the slate of items;
wherein interactions in the set of interactions are respectively associated with items in the slate of items.

110. The recommender system of claim 109, wherein the interactions comprise selections among the items in the slate;
wherein the set of interactions comprises a vector indicating whether the items in the slate were selected or not selected;
wherein the set of interactions indicates that a plurality of items in the slate was selected; and
wherein the interactions comprise user clicks.

111. The recommender system of claim 108, wherein the autoencoder is trained using a dataset comprising a plurality of logged interactions;
wherein the plurality of logged interactions comprise a plurality of data pairs, each data pair comprising a slate of items and an associated set of interactions.

112. The recommender system of claim 108, wherein the autoencoder comprises the decoder and a neural network-based encoder;
wherein the encoder is modeled by a first set of parameters; and
wherein the decoder is modeled by a second set of parameters;
wherein the autoencoder is trained by updating the first and second sets of parameters to optimize a loss function;
wherein the decoder decodes the action to reconstruct embedded items from the slate;
wherein the decoder generates the reconstructed slate of items from the reconstructed item embeddings; and
wherein the decoder derives logits for a set of item probabilities from the reconstructed embeddings and generates the reconstructed slate of items from the derived logits.

113. The recommender system of claim 108, wherein optimizing the loss function comprises maximizing an evidence lower bound (ELBO) on a task of reconstructing slates of items and associated sets of interactions.

114. The recommender system of claim 108, wherein the loss function comprises:
a slate reconstruction loss;
a set of interactions reconstruction loss; and
a prior matching loss;
wherein the slate reconstruction loss, the set of interactions reconstruction loss, and/or the prior matching loss are weighted by a hyperparameter.

115. The recommender system of claim 108, wherein the items comprise identifiers respectively associated with items in the collection;
wherein the items in the collection comprise media items, documents, terms, tokens, news items, e-commerce items, or a combination.

116. The recommender system of claim 108, wherein the agent is trained while the trained decoder is integrated into the recommender system, and while the trained decoder is frozen.

117. The recommender system of claim 108, further comprising:
a belief encoder configured to determine the state based on observed interactions from the user; and
wherein the belief encoder is modeled by a gated recurrent unit (GRU).

118. The recommender system of claim 108, wherein the agent is modeled by an actor-critic algorithm.

119. The recommender system of claim 108, wherein the reinforcement learning agent is defined by a policy; and
wherein said training of the reinforcement learning agent updates the policy to improve a return;
wherein the recommender system is configured to interact with the user throughout an episode of turns;
wherein in each turn the recommender system recommends a slate of items and the user interacts with one or more of the recommended slate of items; and
wherein the return is determined based on a reward over the episode of turns.

120. The recommender system of claim 108, wherein the reward is based on a cumulative number of interactions by the user over the episode.

121. The recommender system of claim 108, wherein the recommender system is embodied in a second stage of a two-stage information retrieval system; and
wherein the information retrieval system further comprises a first stage for retrieving a collection of items in response to a request.
